(19) United States
(12) Patent Application Publication
(10) Pub. No.: US 2022/0180209 A1
(43) Pub. Date: Jun. 9, 2022

(54) AUTOMATIC MACHINE LEARNING SYSTEM, METHOD, AND DEVICE

(71) Applicant: HUAWEI TECHNOLOGIES CO., LTD., Shenzhen (CN)

(72) Inventors: Yuxiao XU, Hangzhou (CN); Ruiyang GAO, Nanjing (CN); Xingze GUO, Hangzhou (CN)

(73) Assignee: HUAWEI TECHNOLOGIES CO., LTD., Shenzhen (CN)

(21) Appl. No.: 17/677,620

(22) Filed: Feb. 22, 2022

Related U.S. Application Data
(63) Continuation of application No. PCT/CN2019/102305, filed on Aug. 23, 2019.

(51) Int. Cl. G06N 3/08; G06V 10/778

(52) U.S. Cl. CPC G06N 3/088; G06V 10/7792

(57) ABSTRACT

This application provides an automatic machine learning method. The method includes: An AutoML system receives a task target of a user and a first data set, and determines, based on the task target, an initial AI model used to implement the task target for the user; the AutoML system trains the initial AI model based on the received first data set, to obtain a trained AI model, and analyzes the training of the initial AI model based on the first data set, to obtain an analysis result, where the analysis result includes the impact of at least one type of data in the first data set on the training of the initial AI model; and the AutoML system provides an optimization manner of the trained AI model for the user based on the analysis result, where the optimization manner may be: uploading a second data set for optimizing the trained AI model.

### CROSS-REFERENCE TO RELATED APPLICATIONS

This application is a continuation of International Application No. PCT/CN2019/102305, filed on Aug. 23, 2019, the disclosure of which is hereby incorporated by reference in its entirety.

### TECHNICAL FIELD

This application relates to the field of artificial intelligence technologies, and specifically, to an automatic machine learning (AutoML) system, method, and device.

### BACKGROUND

At present, artificial intelligence (AI) has attracted extensive attention from academic and industrial circles, and AI is applied more widely, and is beyond a level of ordinary human beings in many application fields. For example, application of AI technologies in the machine vision field (human recognition, image classification, object detection, and the like) makes accuracy of machine vision higher than that of human vision, and AI technologies are also well applied in the field of natural language processing, the field of recommendation systems, and the like.

Machine learning is a core approach to implementation of AI. For a to-be-resolved technical problem, a computer builds an AI model based on existing data, and then uses the AI model to predict a result. In this method, the computer seems to learn an ability (for example, a cognition ability, a discerning ability, or a classification ability) like a human. Therefore, this method is referred to as machine learning. To implement various applications of AI through machine learning, various AI models (for example, a neural network model) need to be used. An AI model is essentially an algorithm, and includes a large quantity of parameters and calculation formulas (or calculation rules). When a machine learning method is used to solve a technical problem, there are a series of problems to address, for example, how to build or select a suitable AI model, and how to optimize the AI model during training, that is, to make a parameter combination in the selected AI model comparatively optimal, so that the AI model has comparatively high accuracy for solving the technical problem. Due to these problems, applying machine learning to a practical problem becomes a skill that can be implemented by only a small number of highly specialized technicians.

In actuality, many enterprises or organizations who possess real data of frontline application scenarios and desire to solve practical problems by using AI lack capabilities in regard to AI, whereas AI providers who collect a large quantity of technologies and talents in regard to AI often find it difficult to obtain real data of frontline application scenarios as a data set for AI model training. Against this background, AutoML systems emerge consequently. An AutoML system is used to provide services such as AI model selection, building, and training for a user based on a task target determined by the user and a data set collected by the user, so that a user who is not proficient in AI technologies can also obtain an AI model capable of completing a specific task and use the AI model to solve a business problem. When an AutoML system in a current technology trains an AI model for a user, feedback on user data quality is comparatively simple. When an AI model trained based on a data set uploaded by a user has not yet reached an ideal status, a platform in the existing AutoML system just simply feeds back a current result (for example, overall precision of the model) or a general optimization approach to the user. As a result, the user is quite confused after obtaining an AI model whose effect is unsatisfactory. If the user expects to further optimize the AI model trained in AutoML, the user can only optimize the AI model blindly by adding a data set or adjusting a quantity proportion of each type of data set, or the like. Because these approaches don't take into account correlations among data, they usually lead to low efficiency of AI model optimization.

### SUMMARY

This application provides an AutoML method, system, and device. In such an AutoML method, AI model training may be analyzed, and an efficient optimization manner is further provided for a user to optimize a trained AI model.

According to a first aspect, this application provides an AutoML method. The method includes: An AutoML system receives a task target of a user and a first data set; determines an initial artificial intelligence AI model based on the task target, where the initial AI model is used to implement the task target for the user; trains the initial AI model based on the first data set, to obtain a trained AI model; analyzes training of the initial AI model based on the first data set, to obtain an analysis result, where the analysis result includes the impact of at least one type of data in the first data set on training of the initial AI model; and provides an optimization manner of the trained AI model for the user based on the analysis result, where the optimization manner includes: uploading a second data set for optimizing the trained AI model.

It should be understood that the task target of the user received by the AutoML system is a function that the user expects to be provided by a final AI model trained by the AutoML system. The user may select a task target or input a task target to the AutoML system on a GUI, or may input a task target by using a command line. It should be further understood that the sequence in which the AutoML system receives the task target of the user and the first data set is not limited. The task target of the user may be received before the first data set uploaded by the user is received.

According to the method, the user can obtain a more specific optimization manner of the trained AI model, so that the user can collect, label, and upload data more aimfully according to the optimization manner recommended by the AutoML system. This prevents the user from blindly adding other workload, and therefore, optimization of the trained AI model is more efficient. Performing optimization analysis on the training of the initial AI model and providing the reliable optimization manner can actually make it easier for the user without professional AI knowledge to obtain a finally satisfactory AI model, so as to complete the task target by using the finally obtained AI model.

In a possible implementation of the first aspect, the method further includes: providing an expected effect of the optimization of the trained AI model to the user, where the expected effect indicates a prediction accuracy that is to be achieved after performing optimization training on the trained AI model based on the second data set.

The expected effect of the optimization of the trained AI model is provided to the user, so that the user can learn of the room for the optimization of the trained AI model, and the user can determine, based on such information and the actual situation, whether to follow the optimization manner recommended by the AutoML system. Alternatively, the user may give up continuing to optimize the trained AI model, after balancing the prediction accuracy of the currently trained AI model, the expected effect of the optimization, and the time and labor costs.

In a possible implementation of the first aspect, the first data set includes a training data set and a test data set; before the analyzing the training of the initial AI model based on the first data set, to obtain an analysis result, the method further includes: evaluating the prediction accuracy of the trained AI model for each type of data in the test data set; and the analyzing the training of the initial AI model based on the first data set, to obtain an analysis result includes: determining at least one type of data in the training data set based on the prediction accuracy of each type of data in the test data set, to analyze the training of the initial AI model; and analyzing the impact of the at least one type of data in the training data set on the training of the initial AI model by using an incremental experiment method, to obtain the analysis result.

In the foregoing evaluation of the trained AI model and analysis of the training of the initial AI model, different impacts of different types of data in the training data set on AI model training are fully considered, thereby ensuring that the optimization manner provided by the AutoML system for the user can optimize the trained AI model more efficiently.

In a possible implementation of the first aspect, the analyzing impact of the at least one type of data in the training data set on the training of the initial AI model by using an incremental experiment method, to obtain the analysis result includes: dividing the training data set into a base set and an incremental set; training the initial AI model by using the base set, to obtain a base AI model; for each of the at least one type of data in the incremental set, dividing the type of data into a plurality of portions, and adding the plurality of portions of data one by one to train the base AI model, to obtain an intermediate AI model; calculating a change amount of prediction accuracy of the intermediate AI model relative to that of the base AI model after each time of training; and obtaining a benefit coefficient of each of the at least one type of data for the prediction accuracy of the intermediate AI model based on the change amount of the prediction accuracy and the type of data.

According to the method, the impact of the at least one type of data in the training data set on training of the initial AI model is fully analyzed by using the mathematical experiment method, and the benefit coefficient of each of the at least one type of data for the prediction accuracy of the intermediate AI model is used as the analysis result. By using this mathematically quantified analysis result, the AutoML system can accurately provide the optimization manner of the trained AI model based on the analysis result, and can also intuitively provide the optimization manner for the user, so that the optimization manner provided for the user is more convincing to the user.

In a possible implementation of the first aspect, the second data set includes one or more types of data, and the type of the data in the second data set is a type of data whose benefit coefficient for the prediction accuracy of the intermediate AI model is greater than a preset threshold. The type of the data in the second data set is obtained through further analysis based on the analysis result of the initial AI model. When the optimization manner is provided for the user, the user is instructed to continue to upload the type of data whose benefit coefficient for the prediction accuracy of the intermediate AI model is greater than the preset threshold. This can improve optimization efficiency of the trained AI model, and can also reduce unnecessary time and labor.

In a possible implementation of the first aspect, the method further includes: receiving the second data set uploaded by the user; and performing optimization training on the trained AI model based on the second data set. After the user uploads the second data set, optimization training continues to be performed on the trained AI model, so that the optimized AI model can better implement the task target of the user.

In a possible implementation of the first aspect, before the analyzing training of the initial AI model based on the first data set, to obtain a trained AI model, the method further includes: classifying data in the first data set based on an attribute of the data in the first data set. According to the method, the AutoML system can separately analyze the type of data under each attribute of the data in the data set when analyzing the training of the initial AI model, so as to fully analyze the impacts of different attribute classifications of data on AI model training, thereby providing more optimization manners for the user.

In a possible implementation of the first aspect, data in the first data set and the second data set has labels, and the types of the data in the first data set and the second data set are the same as the labels of the data in the first data set and the second data set. The AutoML system may analyze, based on labels in the data set uploaded by the user, the impact of data under the label of each type on AI model training, and finally provide an optimization manner of adding data under a label of one or more types, so that the user can continue to collect the second data set based on the manner in which the first data set is collected. In addition, this optimization manner is simple and efficient.

In a possible implementation of the first aspect, the method further includes: preprocessing the data in the received first data set and second data set separately, where the preprocessing includes one or more of the following operations: (1) modifying size specifications of the data; (2) checking the data; (3) encoding and converting the data; (4) classifying the data by attributes; or (5) extracting features of the data.

Before training is performed by using the data in the first data set or the second data set, the data in the data set is preprocessed, so that the data is more suitable for AI model training, thereby improving efficiency of AI model training and prediction accuracy of the AI model obtained through training by using the data.

According to a second aspect, this application provides an AutoML system. The system includes: a user input/output I/O module, configured to receive a task target of a user and a first data set; a model determining module, configured to determine an initial artificial intelligence AI model based on the task target, where the initial AI model is used to implement the task target for the user; a model training module, configured to train the initial AI model based on the first data set, to obtain a trained AI model; and a model optimization analysis module, configured to analyze the training of the initial AI model based on the first data set, to obtain an analysis result, where the analysis result includes the impact of at least one type of data in the first data set on the training of the initial AI model. The user I/O module is further configured to provide an optimization manner of the trained AI model to the user based on the analysis result, where the optimization manner includes: uploading a second data set for optimizing the trained AI model.

In a possible implementation of the second aspect, the user I/O module is further configured to provide an expected effect of the optimization of the trained AI model to the user, where the expected effect indicates a prediction accuracy that is to be achieved after performing optimization training on the trained AI model based on the second data set.

In a possible implementation of the second aspect, the first data set includes a training data set and a test data set; the model optimization analysis module is further configured to evaluate the prediction accuracy of the trained AI model for each type of data in the test data set; and when the model optimization analysis module is configured to analyze the training of the initial AI model based on the first data set, to obtain the analysis result, the model optimization analysis module is configured to: determine at least one type of data in the training data set based on the prediction accuracy for each type of data in the test data set, to analyze the training of the initial AI model; and analyze the impact of the at least one type of data in the training data set on the training of the initial AI model by using an incremental experiment method, to obtain the analysis result.

In a possible implementation of the second aspect, when the model optimization analysis module is configured to analyze the impact of the at least one type of data in the training data set on the training of the initial AI model by using the incremental experiment method, to obtain the analysis result, the model optimization analysis module is configured to: divide the training data set into a base set and an incremental set; train the initial AI model by using the base set, to obtain a base AI model; for each of the at least one type of data in the incremental set, divide the type of data into a plurality of portions, and add the plurality of portions of data one by one to train the base AI model, to obtain an intermediate AI model; calculate a change amount of the prediction accuracy of the intermediate AI model relative to that of the base AI model after each training; and obtain a benefit coefficient of each of the at least one type of data for the prediction accuracy of the intermediate AI model based on the change amount of the prediction accuracy and the type of data.

In a possible implementation of the second aspect, the second data set includes one or more types of data, and the type of the data in the second data set is a type of data whose benefit coefficient for the prediction accuracy of the intermediate AI model is greater than a preset threshold.

In a possible implementation of the second aspect, the user I/O module is further configured to receive the second data set uploaded by the user; and the model training module is further configured to perform optimization training on the trained AI model based on the second data set.

In a possible implementation of the second aspect, the model optimization analysis module is further configured to classify data in the first data set based on an attribute of the data in the first data set.

In a possible implementation of the second aspect, data in the first data set and the second data set has labels, and the types of the data in the first data set and the second data set are the same as the labels of the data in the first data set and the second data set.

In a possible implementation of the second aspect, the system further includes a data preprocessing module, configured to preprocess the received first data set and second data set separately, where the preprocessing includes one or more of the following operations: (1) modifying size specifications of the data; (2) checking the data; (3) encoding and converting the data; (4) classifying the data by attributes; or (5) extracting features of the data.

According to a third aspect, this application provides a computing device. The computing device includes a memory and a processor. The memory is configured to store a group of computer instructions. The processor executes the group of computer instructions stored in the memory, so that the computing device performs the method provided in the first aspect or any one of the possible implementations of the first aspect.

According to a fourth aspect, this application provides a non-transitory readable storage medium. The non-transitory readable storage medium stores computer program code. When the computer program code is executed by a computing device, the computing device performs the method provided in the first aspect or any one of the possible implementations of the first aspect. The storage medium includes but is not limited to a volatile memory, for example, a random access memory, or a non-volatile memory, for example, a flash memory, a hard disk drive (HDD), or a solid-state drive (SSD).

According to a fifth aspect, this application provides a computer program product. The computer program product includes computer program code. When the computer program code is executed by a computing device, the computing device performs the method provided in any one of the first aspect or the possible implementations of the first aspect. The computer program product may be a software installation package. When the method provided in the first aspect or any one of the possible implementations of the first aspect needs to be used, the computer program product may be downloaded to and executed on the computing device.

### BRIEF DESCRIPTION OF DRAWINGS

To describe the technical methods in embodiments of this application more clearly, the following briefly describes the accompanying drawings for the embodiments.

FIG. 1 is a schematic diagram of a structure of an AutoML system 100 according to an embodiment of this application;

FIG. 2 is a schematic diagram of an application scenario of an AutoML system 100 according to this application;

FIG. 3 is a schematic diagram of deployment of an AutoML system 100 according to an embodiment of this application;

FIG. 4 is a schematic diagram of a structure of a computing device 200 on which an AutoML system 100 is deployed according to an embodiment of this application;

FIG. 5 is a schematic flowchart of an automatic machine learning method according to an embodiment of this application;

FIG. 6 is a schematic flowchart of a method for analyzing training of an initial AI model according to an embodiment of this application;

FIG. 7 is a schematic diagram of a GUI of prediction accuracy of a trained AI model for each type in a test data set according to an embodiment of this application;

FIG. 8 is a schematic diagram of calculating a total benefit coefficient of adding type-A data for an intermediate AI model according to an embodiment of this application;

FIG. 9 is a schematic diagram of a GUI that provides an optimization manner and an analysis result according to an embodiment of this application;

FIG. 10 is a schematic diagram of a GUI that displays a prediction accuracy curve graph of an AI model according to an embodiment of this application;

FIG. 11 is a schematic flowchart of another automatic machine learning method according to an embodiment of this application; and

FIG. 12 is a schematic diagram of a structure of a computing device according to an embodiment of this application.

### DESCRIPTION OF EMBODIMENTS

The following describes the solutions in the embodiments provided in this application with reference to the accompanying drawings in this application.

Currently, the artificial intelligence (AI) field is booming. Machine learning is a core approach to implementation of AI, and machine learning has permeated various industries such as medicine, transportation, education, and finance. Not only professionals but also non-AI technology professions in various industries expect to complete specific tasks by using AI and machine learning.

For ease of understanding the technical solutions and embodiments provided in this application, concepts such as an AI model, AI model training, and an automatic machine learning (AutoML) system are described in detail below.

An AI model is a mathematical algorithm model for solving an actual problem by using machine learning concepts. An AI model includes a large quantity of parameters and calculation formulas (or calculation rules). Parameters in an AI model are values, for example, weights of calculation formulas or factors in the AI model, that can be obtained through AI model training performed by using a data set. An AI model further includes some hyperparameters. A hyperparameter is a parameter that cannot be obtained through AI model training performed by using a data set. A hyperparameter may be used to guide AI model building or AI model training. There is a plurality of types of hyperparameters, for example, a quantity of iterations of AI model training, a learning rate, a batch size, a quantity of layers of an AI model, and a quantity of neurons at each layer. In other words, the difference between a hyperparameter and parameter of an AI model lies in that the value of a hyperparameter cannot be obtained by analyzing data in a data set, whereas the value of a model parameter can be modified and determined through analysis based on data in a data set.

There are various AI models. A comparatively widely used type of AI model is a neural network model. A neural network model is a type of mathematical algorithm model that emulates the structure and function of a biological neural network (a central nervous system of animals). One neural network model may include a plurality of neural network layers with different functions, and each layer includes a parameter and a calculation formula. Based on different calculation formulas or different functions, different layers in a neural network model have different names. For example, a layer for convolution calculation is referred to as a convolutional layer, and the convolutional layer is usually used to perform feature extraction on an input signal (for example, an image). One neural network model may alternatively include a combination of a plurality of existing neural network models. Neural network models of different structures may be used for different scenarios (for example, classification and recognition), or provide different effects when used for the same scenario. That structures of neural network models are different includes one or more of the following: quantities of network layers in the neural network models are different, sequences of the network layers are different, or weights, parameters, or calculation formulas at the network layers are different. A plurality of different types of neural network models that have comparatively high accuracy and that are used for application scenarios such as recognition or classification already exist in the industry. Some of the neural network models, after being trained by using a specific data set, may be separately used to complete a task, or complete a task in combination with another neural network model (or another function module).

Besides neural network models, most other AI models also need to be trained before being used to complete a task. AI model training means using existing data and a specific method to make an AI model fit a regular pattern of the existing data, and determine parameters in the AI model. To train an AI model, a data set needs to be prepared. Based on whether data in the data set has a label (that is, whether the data has a specific type or name), AI model training may be classified into supervised training and unsupervised training. When supervised training is performed on the AI model, the data in the data set used for training has a label. During AI model training, the data in the data set is used as input of the AI model, the label corresponding to the data is used as a reference of an output value of the AI model, a loss value between the output value of the AI model and the label corresponding to the data is calculated by using a loss function, and parameters in the AI model are adjusted based on the loss value. The AI model is iteratively trained by using each piece of data in the data set, and the parameters of the AI model are continuously adjusted until the AI model can output, with comparatively high accuracy based on the input data, an output value that is the same as the label corresponding to the data. When unsupervised training is performed on the AI model, the data in the data set used for training has no label. The data in the data set is sequentially input to the AI model, and the AI model gradually identifies an association between the data and a potential rule in the data until the AI model can be used to determine or identify a type or feature of the input data, for example, clustering. After receiving a large amount of data, an AI model used for clustering can obtain a feature of each piece of data and an association and a difference between the data through learning, and automatically classify the data into a plurality of types. Different AI models may be used for different task types. Some AI models can be trained only in a supervised learning manner. Some AI models can be trained only in an unsupervised learning manner. Some AI models can be trained in the supervised learning manner, and can also be trained in the unsupervised learning manner. A completely trained AI model can be used to complete a specific task. Generally, AI models in machine learning all need to be trained in the supervised learning manner. Through AI model training in the supervised learning manner, an AI model can learn, in a data set with labels, an association between data in the data set and the corresponding labels in a more targeted manner, so that a completely trained AI model has comparatively high accuracy when being used to predict other input data.

The following uses an example of training, in the supervised learning manner, a neural network model used for an image classification task: To train a neural network model used to complete an image classification task, data is first collected based on the task, to construct a data set. The constituted data set includes three types of images: apple, pear, and banana. The collected images are stored in three folders respectively based on the types, and the name of the folder is the label of all images in the folder. After the data set is constructed, a neural network model (for example, a convolutional neural network (CNN)) that can implement image classification is selected, and the images in the data set are input to the CNN. A convolution kernel at each layer in the CNN performs feature extraction and feature classification on the images, and finally, confidence at which the image belongs to each type is output. A loss value is calculated by using a loss function and based on the confidence and the label corresponding to the image. A parameter of each layer in the CNN is updated based on the loss value and a structure of the CNN. The foregoing training process is continuously performed, and training does not end until the loss value output by the loss function converges or all the images in the data set have been used for training.

A loss function is a function used to measure the extent to which an AI model is trained (that is, used to calculate a difference between a prediction result of the AI model and an actual target). In an AI model training process, because it is expected that the output of an AI model is as close as possible to the value that is actually desired to be predicted, a predicted value obtained by the current AI model based on an input image may be compared with the actually desired target value (namely, the label of the input image), and then, parameters in the AI model are updated based on the difference between the predicted value and the target value (certainly, before the first update, there is usually an initialization process, that is, the initial values are preconfigured for the parameters in the AI model). During each training, the difference between the value predicted by the current AI model and an actual target value is determined by using a loss function, to update parameters of the AI model. When the AI model can predict the actually desired target value or a value that is quite close to the actually desired target value, it is considered that the training of the AI model is completed.

An automatic machine learning (AutoML) system is a system used to automatically complete a machine learning process. Various AI models or AI submodels for solving different problems are built into an AutoML system. An AutoML system can search for and establish suitable AI models based on user requirements. A user only needs to determine a user requirement on a platform in an AutoML system, and upload, to the AutoML system, a data set prepared according to a prompt, and the AutoML system can obtain, for the user through training, an AI model that can be used to meet the user requirement. The user may use the completely trained AI model to complete a specific task of the user. Machine learning is a complex development process that requires technical experience, and therefore, an AutoML system effectively reduces development costs and lowers access thresholds for AI applications.

In an AI model training process, AutoML systems in a conventional technology generally exhibit the problem of a comparatively weak analysis capability and an inability to provide a comparatively good model optimization manner for a user. To solve this problem, the embodiments of this application provide a type of AutoML system that can deeply analyze the impacts of different types of data on AI model training, predict the effect of adding one or more types of data on AI model optimization, and further provide an AI model optimization suggestion for a user. The system is used to perform operations such as data preprocessing, searching for or selecting a suitable AI model based on a task of a user, AI model training and hyperparameter optimization, and deep optimization analysis of an AI model.

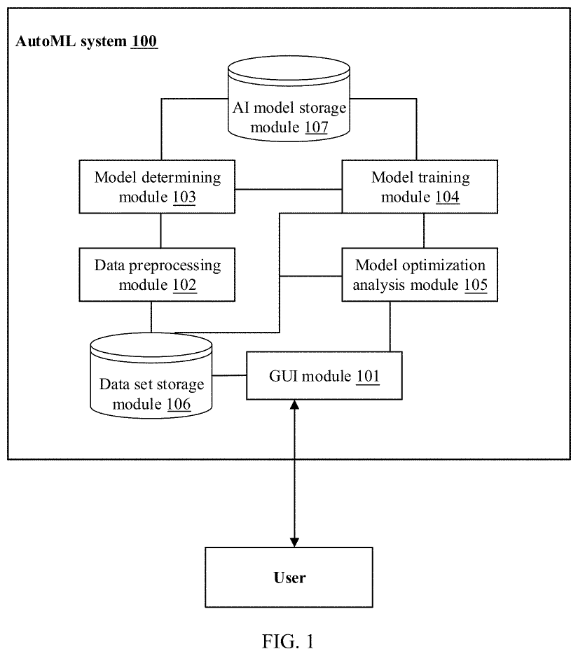

FIG. 1 is a schematic diagram of a structure of an AutoML system 100 according to an embodiment of this application. It should be understood that FIG. 1 is merely an example of a schematic diagram of a structure of the AutoML system 100, and module division in the AutoML system 100 is not limited in this application. As shown in FIG. 1, the AutoML system 100 includes a user input/output (I/O) module 101, a data preprocessing module 102, a model determining module 103, a model training module 104, a model optimization analysis module 105, a data set storage module 106, and an AI model storage module 107.

The following briefly describes a function of each module in the AutoML system 100.

The user I/O module 101 is configured to receive a task target input or selected by a user, receive a data set uploaded by the user, and provide the user with an AI model training analysis result, a model optimization manner, and/or an expected effect of AI model optimization. As an example of the user I/O module 101, a graphical user interface (GUI) may be used for implementation. For example, the GUI displays four AI services that the AutoML system can provide for the user: an image classification service, a facial recognition service, a video similarity detection service, and a vehicle license plate recognition service. The user may select a task target on the GUI. For example, if the user selects the facial recognition service, the user continues to upload, on the GUI of AutoML, a data set used for training a facial recognition AI model. After receiving the task target and the data set, the GUI communicates with the data set storage module 106 and the model determining module 103. The data set storage module 106 stores the data set uploaded by the user. The model determining module 103 selects, or searches to build, for the user based on the task target determined by the user, an AI model that can be used to complete the task target of the user. The user I/O module 101 is further configured to receive an AI model training analysis result and an optimization manner that are obtained by the model optimization analysis module 105.

Optionally, the user I/O module 101 may be further configured to receive a user input of an effect expectation for an AI model completing the task target, for example, the user inputs or selects that accuracy of a finally obtained AI model for facial recognition needs to be higher than 99%.

Optionally, the user I/O module 101 may be further configured to provide various built-in initial AI models for the user to select from. For example, the user may select an initial AI model on the GUI based on the task target of the user.

Optionally, the user I/O module 101 may be further configured to receive various types of configuration information from the user for the initial AI model and the data set, and the like.

The data preprocessing module 102 is configured to perform a preprocessing operation on the data set uploaded by the user. The data preprocessing module 102 may read, from the data set storage module 106, the data set uploaded by the user, or the data preprocessing module 102 directly receives the data set uploaded by the user, and then preprocesses data in the data set. Preprocessing the data set uploaded by the user can make the data in the data set consistent in size, and can further remove improper data from the data set. A preprocessed data set can be suitable for training the initial AI model, and can further improve the training effect. After completing preprocessing the data set, the data preprocessing module 102 stores the preprocessed data set in the data set storage module 106, or sends the preprocessed data set to the model training module 104.

The model determining module 103 is configured to determine, for the user based on the task target of the user, an initial AI model used to complete the task target of the user. The model determining module 103 can communicate with each of the user I/O module 101, the model training module 104, and the AI model storage module 107. The model determining module 103 selects, based on the task target of the user, a ready initial AI model from an AI model library stored in the AI model storage module 107. Alternatively, the model determining module 103 searches for an initial AI submodel structure in an AI model library based on the task target of the user, an effect expected by the user for the task target, or some configuration parameters input by the user, and specifies some hyperparameters of the initial AI model, for example, the quantity of layers of the model and the quantity of neurons at each layer, to build the initial AI model, so as to finally obtain a complete initial AI model. After determining the initial AI model used to complete the task target, the model determining module 103 sends the initial AI model to the model training module 104, or sends name information, address information, or the like of the initial AI model in the AI model storage module, so that the model training module 104 can train the initial AI model. It should be noted that some hyperparameters of the initial AI model may be hyperparameters determined by the AutoML system based on experience of building and training initial AI models.

Optionally, the model determining module 103 may be further configured to determine, as the initial AI model, an AI model selected by the user on the GUI.

The model training module 104 is configured to perform automatic training on the determined initial AI model based on the preprocessed data set. The model training module 104 reads the preprocessed data set from the data preprocessing module 102 or the data set storage module 106, and the model training module 104 obtains the determined initial AI model from the model determining module 103 or the AI model storage module 107. The model training module 104 determines, based on characteristics of the data set and the structure of the initial AI model, some hyperparameters to be used during the training of the initial AI model, for example, a quantity of iterations, a learning rate, and a batch size. After the hyperparameters are set, the model training module 104 performs automatic training on the initial AI model by using the obtained data set, and continuously updates parameters in the AI model in a training process. It should be noted that some hyperparameters used during the training of the initial AI model may be hyperparameters determined by the AutoML system based on model training experience.

The model optimization analysis module 105 is configured to analyze the training of the initial AI model, and analyze an AI model training effect, a manner in which a trained AI model obtained by the model training module 104 may be further optimized, and an expected effect of the optimization. In a process of training the initial AI model, the model optimization analysis module 105 analyzes the impact of each type of data in the data set on the training of the initial AI model, obtains, through analysis, data types that improve the effect of the initial AI model to a comparatively greater extent, and further analyzes an expected effect that can be achieved through optimization of the initial AI model if data of such data types is added for further training of the initial AI model. The model optimization analysis module 105 provides an optimization manner for the user based on an analysis result, and the model optimization analysis module 105 sends the analysis result and the optimization manner to the user I/O module 101.

The data set storage module 106 is configured to store the data set uploaded by the user, and is also configured to store the data set processed by the data preprocessing module 102. It should be understood that, in another embodiment, the data set storage module 106 may be alternatively used as a part of the data preprocessing module 102, that is, the data preprocessing module 102 has a data set storage function.

The AI model storage module 107 is configured to store preconfigured AI models and AI submodel structures, and may also be configured to store an initial AI model newly built based on an AI submodel structure. It should be understood that, in another embodiment, the AI model storage module 107 may be alternatively used as a part of the model determining module 103.

Due to functions of the foregoing modules, the AutoML system provided in this embodiment of this application can provide AI model determining and training services for the user, and the system can deeply analyze the impacts of different types of data on AI model training, predict an analysis result such as an effect of adding one or more types of data on AI model optimization, and further provide an AI model optimization manner for the user.

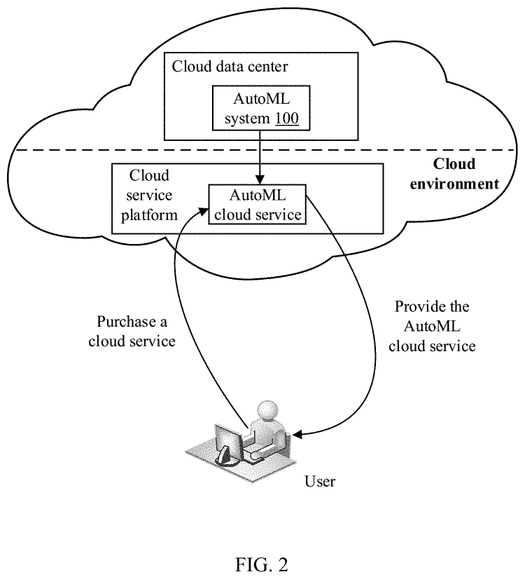

FIG. 2 is a schematic diagram of an application scenario of an AutoML system 100 according to an embodiment of this application. As shown in FIG. 2, in an embodiment, the AutoML system 100 may be entirely deployed in a cloud environment. The cloud environment is an entity that uses basic resources to provide a cloud service for a user in a cloud computing mode. The cloud environment includes a cloud data center and a cloud service platform. The cloud data center includes a large quantity of basic resources (including computing resources, storage resources, and network resources) owned by a cloud service provider. The computing resources included in the cloud data center may be a large quantity of computing devices (for example, servers). The AutoML system 100 may be independently deployed on a server or a virtual machine in the cloud data center, or the AutoML system 100 may be deployed in a distributed manner on a plurality of servers in the cloud data center, or deployed in a distributed manner on a plurality of virtual machines in the cloud data center, or deployed in a distributed manner on servers and virtual machines in the cloud data center. As shown in FIG. 2, the cloud service provider abstracts the AutoML system 100 into an AutoML cloud service on the cloud service platform, and provides the AutoML cloud service for the user; after the user purchases the cloud service on the cloud service platform (the user may recharge an account in advance, and then perform settlement based on a final status of resource usage), the cloud environment provides the AutoML cloud service for the user by using the AutoML system 100 deployed in the cloud data center. When using the AutoML cloud service, the user may use an application programming interface (API) or a GUI to determine a task to be completed by an AI model, and upload a data set to the cloud environment. The AutoML system 100 in the cloud environment receives task information of the user and the data set, and performs operations such as data preprocessing, AI model determining, AI model training, and AI model optimization analysis. The AutoML system returns content such as an effect of a trained AI model, an optimization manner of the trained AI model, and an expected effect of optimization to the user by using the API or the GUI. The user further uploads a data set according to the optimization manner or gives up optimization. A completely trained AI model may be downloaded by the user or used online, to complete a specific task.

In another embodiment of this application, when the AutoML system 100 in the cloud environment is abstracted into the AutoML cloud service to be provided for the user, the AutoML cloud service may be divided into two parts: a basic AutoML cloud service and a value-added AI model optimization analysis cloud service. The user may first purchase only the basic AutoML cloud service on the cloud service platform, and then purchase the value-added AI model optimization analysis cloud service when the value-added AI model optimization analysis cloud service needs to be used. After the value-added AI model optimization analysis cloud service is purchased, the cloud service provider provides a value-added AI model optimization analysis API. Finally, additional charges are billed on the value-added AI model optimization analysis cloud service based on the quantity of times that the API is called.

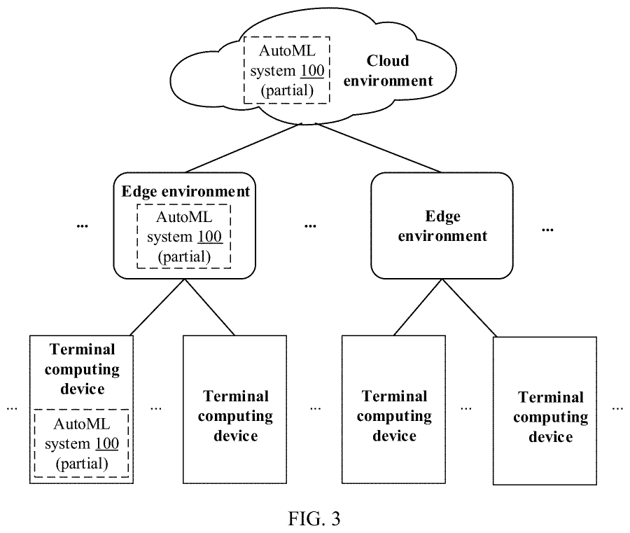

Deployment of the AutoML system 100 provided in this application is comparatively flexible. As shown in FIG. 3, in another embodiment, the AutoML system 100 provided in this application may be alternatively deployed in different environments in a distributed manner. The AutoML system 100 provided in this application may be logically divided into a plurality of parts, and each part has a different function. For example, in an embodiment, the AutoML system 100 includes a user I/O module 101, a data preprocessing module 102, a model determining module 103, a model training module 104, a model optimization analysis module 105, a data set storage module 106, and an AI model storage module 107. The parts of the AutoML system 100 may be separately deployed in any two or three of the following environments: a terminal computing device, an edge environment, and a cloud environment. Terminal computing devices include a terminal server, a smartphone, a notebook computer, a tablet computer, a personal desktop computer, a smart camera, and the like. The edge environment is an environment that includes a set of edge computing devices that are comparatively close to the terminal computing device, and the edge computing devices include an edge server, an edge station with computing power, and the like. The parts of the AutoML system 100 that are deployed in different environments or devices cooperate in providing the user with functions such as determining and training an initial AI model. For example, in a scenario, the user I/O module 101, the data preprocessing module 102, and the data set storage module 106 in the AutoML system 100 are deployed in the terminal computing device, and the model determining module 103, the model training module 104, the model optimization analysis module 105, and the AI model storage module 107 in the AutoML system 100 are deployed in the edge computing device in the edge environment. The user sends a collected data set to the user I/O module 101 in the terminal computing device. The terminal computing device stores the data set in the data set storage module 106. The data preprocessing module 102 preprocesses the data set, and also stores a preprocessed data set in the data set storage module 106. The model determining module 103 in the edge computing device determines an initial AI model based on a task target of the user. Further, the model training module 104 and the model optimization analysis module 105 perform training and optimization analysis on the determined initial AI model in the AI model storage module 107 by using the preprocessed data set stored in a data storage device. It should be understood that, in this application, which parts of the AutoML system 100 are deployed in which environment is not limited. In an actual application, adaptive deployment may be performed based on the computing capability of the terminal computing device, resource occupation statuses of the edge environment and the cloud environment, or a specific application requirement.

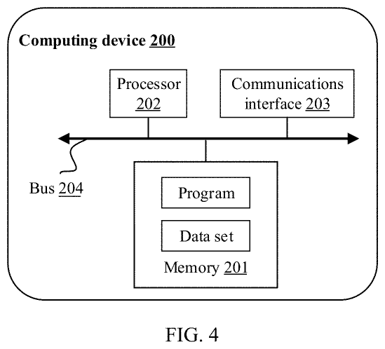

Alternatively, the AutoML system 100 may be independently deployed on a computing device in any environment (for example, independently deployed on an edge server in the edge environment). FIG. 4 is a schematic diagram of a hardware structure of a computing device 200 on which the AutoML system 100 is deployed. The computing device 200 shown in FIG. 4 includes a memory 201, a processor 202, a communications interface 203, and a bus 204. The memory 201, the processor 202, and the communications interface 203 are communicatively connected to each other through the bus 204.

The memory 201 may be a read-only memory (ROM), a static storage device, a dynamic storage device, or a random access memory (RAM). The memory 201 may store a program. When the program stored in the memory 201 is executed by the processor 202, the processor 202 and the communications interface 203 are configured to perform a method for training and optimizing an AI model for the user by the AutoML system 100. The memory may further store a data set. For example, some of storage resources in the memory 201 are grouped into a data set storage module 106, configured to store a data set required by the AutoML system 100, and some of the storage resources in the memory 201 are grouped into an AI model storage module 107, configured to store an AI model library.

The processor 202 may be a general-purpose central processing unit (CPU), a microprocessor, an application-specific integrated circuit (ASIC), a graphics processing unit (GPU), or one or more integrated circuits.

Alternatively, the processor 202 may be an integrated circuit chip having a signal processing capability. In an implementation process, a function of the AutoML system 100 in this application may be implemented by using an integrated logic circuit of hardware in the processor 202 or instructions in a form of software. The processor 202 may alternatively be a general-purpose processor, a digital signal processor (DSP), an application-specific integrated circuit (ASIC), a field programmable gate array (FPGA) or another programmable logic device, a discrete gate or transistor logic device, or a discrete hardware component, which can implement or perform the methods, steps, and logical block diagrams that are disclosed in the following embodiments of this application. The general-purpose processor may be a microprocessor, or the processor may be any conventional processor or the like. Steps of the methods disclosed with reference to the following embodiments of this application may be directly executed and completed by using a hardware decoding processor, or may be executed and completed by using a combination of hardware in a decoding processor and a software module. The software module may be located in a mature storage medium in the art, such as a random access memory, a flash memory, a read-only memory, a programmable read-only memory, an electrically erasable programmable memory, or a register. The storage medium is located in the memory 201. The processor 202 reads information in the memory 201, and implements a function of the AutoML system 100 in this embodiment of this application in combination with hardware of the processor 202.

The communications interface 203 uses, for example but not limited to, a transceiver module such as a transceiver to implement communication between the computing device 200 and another device or a communications network. For example, a data set may be obtained through the communications interface 203.

The bus 204 may include a path for transmitting information between components (for example, the memory 201, the processor 202, and the communications interface 203) of the computing device 200.

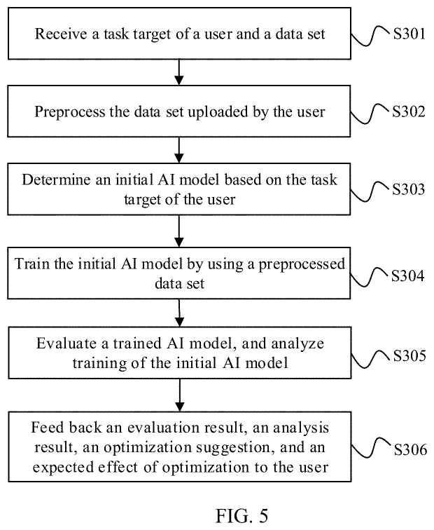

The following describes a specific procedure of an automatic machine learning AutoML method in an embodiment with reference to FIG. 5. The method is performed by an

AutoML system 100.

S301: Receive a task target of a user and a data set.

Specifically, the AutoML system 100 may receive the task target of the user by using a user I/O module (for example, a GUI). The task target is, for example, that the user wants to obtain an AI model that can be used to detect and recognize text on an express delivery number, or that the user wants to obtain an AI model that can be used to accurately recognize images containing various fruits. After receiving a task of the user, the AutoML system provides a prompt for the user, requesting the user to upload the collected data set according to the prompt. The AutoML system receives the data set uploaded by the user.

It should be noted that the AutoML system 100 may further receive two data sets, namely, a training data set and a test data set, uploaded by the user. The training data set is used to train an initial AI model determined for completing the task target. The test data set is used to test the AI model that has been trained by using the training data set, and evaluate prediction accuracy of the trained AI model. It should be noted that, when the AutoML system 100 receives only one data set uploaded by the user, the AutoML system 100 may automatically divide the data set uploaded by the user into a training data set and a test data set.

Optionally, the AutoML system 100 may further receive an effect expectation for a final AI model that is input by the user on the GUI (for example, it is expected that detection and recognition accuracy of the final AI model is higher than 99%).

Optionally, the AutoML system 100 may further receive a preconfigured AI model selected by the user, and use, as the initial AI model, the preconfigured AI model selected by the user.

Optionally, the AutoML system 100 may further receive various types of configuration information from the user for the initial AI model and the data set, and the like.

S302: Preprocess the data set uploaded by the user.

In this step, a preprocessing method includes one or more of the following operations:

1. automatically scaling or normalizing a size specification of data in the data set uploaded by the user;

2. checking the data in the data set uploaded by the user, and removing individual data that seriously affects a model training effect;

3. checking a label of the data in the data set uploaded by the user, and removing or correcting data whose data content is inconsistent with a data label in labeled data;

4. converting and encoding the data in the data set;

5. extracting a feature of the data in the data set;

6. dividing the data in the data set into a training data set and a test data set, where a division proportion may vary with different task targets of the user, and when the data set is one data set that includes a plurality of different types of data, each of the training data set and test data set obtained through division should include each type of data; or p 7. performing classification on the data set by attributes, where for example, when the data set includes license plates of a plurality of nations, classification may be performed on the data set based on attributes such as license plate colors or lengths of characters on the license plates.

It should be understood that a preprocessing operation performed on the data set is not limited to the foregoing several operations, and some other preprocessing may be adaptively performed based on the task target and a status of the data set uploaded by the user. It should be understood that, when a plurality of preprocessing operations are performed on the data set, the data set may be preprocessed sequentially based on the types of the preprocessing operations.

It should be noted that, when two data sets, namely, the training data set and the test data set, are uploaded by the user, the same preprocessing operation is performed on the two data sets separately. It should be noted that, when the data set uploaded by the user is one data set, preprocessing of the data set in S302 is as follows: The data set uploaded by the user is first divided into one training data set and one test data set, and then the same preprocessing operation is performed on the training data set and the test data set.

S303: Determine the initial AI model based on the task target of the user.

In this step, the AutoML system 100 determines, as the initial AI model used to complete the user task, an AI model of a complete structure in an AI model library based on the task target of the user. Alternatively, the AutoML system 100 determines some hyperparameters of the initial AI model, for example, a quantity of layers of the model and a quantity of neurons at each layer, based on the task target of the user, and the AutoML model searches for an AI submodel structure in the AI model library based on the task target of the user. Further, the AutoML system 100 builds the AI model based on the hyperparameters and the AI submodel structure, to finally obtain a complete initial AI model. It should be understood that a method for determining the initial AI model is not limited in this application. Some other methods for determining and building an initial AI model in the conventional technology are also applicable to this step in this embodiment of this application. It should be understood that the initial AI model in this application is an AI model that is determined by the AutoML system 100 based on the task target of the user and that has not been trained by using the data set uploaded by the user.

S304: Train the initial AI model by using a preprocessed data set.

In this step, a preprocessed training data set obtained in S302 is used to train the initial AI model determined in S303. Before training, some hyperparameters for model training, for example, a quantity of iterations, a learning rate, and a batch size, may be determined based on training experience, characteristics of the preprocessed training data set, and characteristics of the initial AI model. In a training manner, training is performed on the initial AI model based on specified hyperparameters; during training, a loss value between a predicted value, for an input image, obtained by an AI model undergoing a training process and a target value is calculated by using a loss function, and parameters of the AI model in the training process are updated based on the loss value, until all data in the training data set has been used for training based on the specified hyperparameters. It should be understood that a specific manner of training the initial

AI model is not limited in this application. Training methods may vary correspondingly with different structures of the initial AI model and different specified hyperparameters for training, but all training needs to be performed by using the training data set. In addition, the purpose of training is to make the initial AI model learn characteristics and patterns of the data in the training data set, so that the initial AI model can perform prediction on any other data similar to or of the same type as the data in the training data set.

S305: Evaluate the trained AI model, and analyze the training of the initial AI model.

In step S304, training is performed on the initial AI model based on the training data set. In step S305, the AutoML system 100 evaluates the trained AI model by using the test data set, that is, uses data in the test data set as input of the trained AI model, and calculates prediction accuracy of the trained AI model for the test data. When the data set includes a plurality of types of data, in evaluation of the trained AI model, prediction accuracy of the trained AI model for each type of data in the test data set may be separately calculated. After the trained AI model is evaluated, an evaluation result is compared with the effect expectation for the final AI model that is input by the user on the GUI in advance. When the trained AI model does not reach the effect expectation, the impacts of several types of data for which prediction accuracy of the trained AI model are comparatively poor are further analyzed on prediction accuracy of the AI model for the same types of data and prediction accuracy of the AI model for other types of data in a process of training the initial AI model. An incremental experiment method may be used to analyze a change status of prediction accuracy of the AI model each time a fixed amount of training data is added for AI model training. Further, an expected effect of prediction accuracy of an AI model obtained through optimization training by continuing to add one or more types of data may be predicted based on a curve relationship between an amount of data used for AI model training and prediction accuracy of the AI model. A specific procedure of an embodiment of evaluating the trained AI model and training the initial AI model is described in S3051 to S3054 below.

Optionally, after the trained AI model is evaluated in S305, the evaluation result is compared with the effect expectation for the AI model that is input by the user on the GUI in advance. When the trained AI model reaches the effect expectation, further analysis is no longer performed in S305; instead, the GUI notifies the user that the AI model meeting the effect expectation of the user is already obtained through training, and provides the user with downloading of the completely trained AI model, or notifies the user that the completely trained AI model may be used online.

S306: Feed back the evaluation result, an analysis result, an optimization manner, and an expected effect of optimization to the user.

The evaluation result of the trained AI model can be obtained based on the evaluation in S305. The evaluation result includes prediction accuracy exhibited by the currently trained AI model for the test data set (for a data set with a plurality of data types, the evaluation result further includes prediction accuracy of the trained AI model for each type of data). The analysis result of training of the initial AI model can be obtained based on the analysis in S305. The analysis result includes a change amount of prediction accuracy of an intermediate AI model relative to that of a base AI model after each training, and a benefit coefficient of each of the at least one type of data for the prediction accuracy of the intermediate AI model is obtained based on the change amount of the prediction accuracy and the type of data. The optimization manner is a method, for optimizing the trained AI model, recommended by the AutoML system 100 to the user based on the analysis result. For example, the training data set includes data of four types: A, B, C, and D. Based on the analysis result, it is found that adding type-A data whose amount is 10% of a total amount of the data in the training data set can improve prediction accuracy of the AI model for type-A data, and can also improve prediction accuracy for type-B data and type-C data. In this case, the optimization manner is “adding type-A data whose amount is 10% of the total amount of the data in the training data set”. The AutoML system 100 further feeds back, to the user, the expected effect of optimization performed in the optimization manner. For example, after type-A data whose amount is 10% of the total amount of the data in the training data set is added, an expected effect of the AI model is that prediction accuracy of the AI model for type-A data is expected to increase by 4.2%, prediction accuracy of the AI model for type-B data is expected to increase by 1.5%, and prediction accuracy of the AI model for type-C data is expected to increase by 6.3%.

It should be understood that, after the user uploads a newly added training data set according to the optimization manner provided by the AutoML system 100, the AutoML system 100 uses the trained AI model as an initial AI model, and performs a procedure similar to S302, S304, S305, and S306 by using the newly added training data set. The procedure is: preprocessing data in the newly added training data set; continuing to perform, by using a training data set obtained by preprocessing the newly added training data set, optimization training on the trained AI model obtained through determining in S303 and training in S304; evaluating and analyzing an AI model obtained through optimization training; and further providing an analysis result, an optimization manner, and an expected effect of optimization for the user. When the user chooses to no longer follow the optimization manner, or it is determined, through comparison between the prediction accuracy of the currently trained AI model and the user-preset effect expectation after the AI model is trained in S304, that the currently trained AI model already meets the effect expectation of the user, the AutoML system no longer performs a procedure similar to S302, S304, S305, and S306, but notifies, on the GUI, the user that the AI model has been trained based on a user requirement, and that the currently trained AI model may be downloaded by the user or used online.

Through the method procedure of automatic machine learning by the AutoML system 100 in S301 to S306, the user can obtain the AI model training analysis result, the optimization manner of the trained AI model, and the expected effect of optimization that contain more information, so that the user can determine, based on such information and the actual situation, whether to follow the optimization manner recommended by the AutoML system. Alternatively, the user may give up continuing to optimize the trained AI model, after balancing the prediction accuracy of the currently trained AI model, the expected effect of optimization, and the time and labor costs. Performing optimization analysis on AI model training and providing the reliable optimization manner can actually make it easier for the user without professional AI knowledge to obtain a satisfactory AI model, so as to complete the task target by using the AI model.

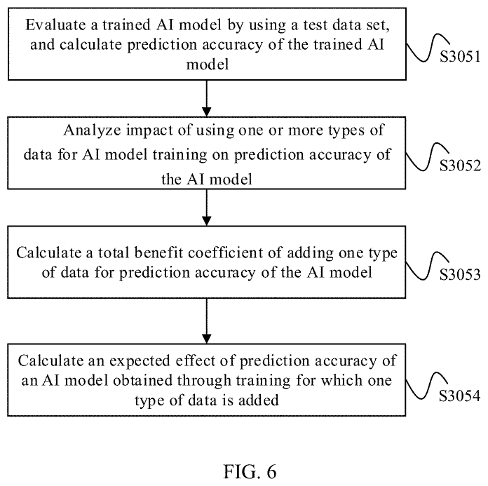

FIG. 6 is a schematic flowchart of a specific method for evaluating the trained AI model and analyzing the training of the initial AI model in an embodiment. With reference to FIG. 6, the method for AI model evaluation and analysis in S305 is described in detail below by using an example in which the task target of the user is to obtain an AI model used for image classification, and the data set uploaded by the user is one training data set that includes data of four types A, B, C, and D and one test data set that includes data of the four types A, B, C, and D.

S3051: Evaluate the trained AI model by using the test data set, and calculate prediction accuracy of the trained AI model for each type.

Specifically, data in the test data set is sequentially input to the trained AI model, and the trained AI model outputs a predicted type corresponding to each piece of input data. Further, the predicted type is compared with an actual type of the input data, and prediction accuracy of the trained AI model for the data of the four types A, B, C, and D in the test data set is separately calculated. Prediction accuracy for each type is a ratio of the number of the type of data accurately predicted by the AI model in the test data set to the total number of the type of data in the test data set. For example, there are 20 type-A images in total in the test data set, and after the 20 images are separately input to the trained AI model for prediction, the trained AI model accurately predicts that 18 of the images are type-A images. In this case, prediction accuracy of the trained AI model for the type A is 90%.

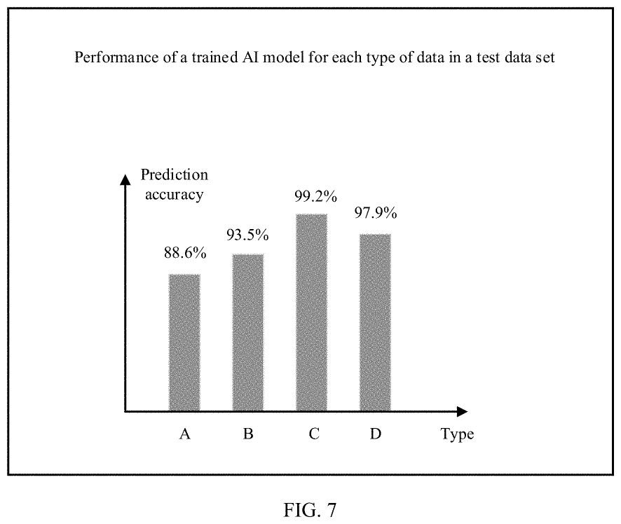

It should be noted that, in S306, prediction accuracy of the trained AI model for each type in the test data set may be displayed to the user by the GUI, so that the user intuitively obtains the performance of the currently trained AI model for each type of data. For example, FIG. 7 is a schematic diagram of prediction accuracy, presented on the GUI, of the trained AI model for each type in the test data set.

S3052: Analyze the impact of using one or more types of data for training the AI model on prediction accuracy of the AI model.

Specifically, N types with comparatively poor prediction accuracy in the training data set are determined based on the prediction accuracy, of the trained AI model for each type, obtained in S3051, and incremental experiment is performed on the N types separately. N is a positive integer greater than or equal to 1, and a value of N may be determined by a combination of a plurality of factors, for example, time costs of training and a prediction accuracy ranking of the current AI model. For example, for the prediction accuracy shown in FIG. 7, it is determined that a value of N is 2, and the type A and the type B are selected for incremental experiment.

The main idea of incremental experiment is as follows: retraining the initial AI model by using a base set, to obtain the base AI model, and evaluating prediction accuracy of the base AI model for each type of data in the test data set; and then, gradually adding data type by type to train the base AI model, to obtain a correlation coefficient between an incremental sequence of one type of data and a prediction accuracy change amount sequence of the AI model for each type of data in the test data set. An incremental sequence of one type of data may be represented as [NA₁, NA₂, . . . , NAᵢ, . . . , NAₖ], where i and k are both positive integers greater than 0, and i is less than or equal to k. NAᵢ represents a quantity of pieces of data of the type that are used for AI model training after the i^{th} time of data adding, and NAₖ represents a quantity of pieces of data of the type that are used for AI model training after the last time of data adding. In a process of gradually adding data type by type to train the AI model, a prediction accuracy change amount sequence of the AI model for the j^{th} type of data in the test data set may be represented as [ΔPA^{j}₁, ΔPA^{j}₂, . . . , ΔPA^{j}ᵢ, . . . , ΔPA^{j}ₖ], where j is a positive integer greater than 0. It should be understood that prediction accuracy increment sequences corresponding to all types of data in the test data set can be obtained by gradually adding data type by type for AI model training. For example, prediction accuracy increment sequences of the AI model for data of the four types A, B, C, and D in the test data set in a process of adding type-A data to train the AI model can be obtained by adding type-A data to train the AI model. The following describes, by using an example in which incremental experiment is performed on type-A data, a specific method for analyzing impact of adding type-A data to train the AI model on prediction accuracy of the AI model for the data types A, B, C, and D. Specific steps are as follows:

1: Divide the preprocessed training data set into the base set and an incremental set, where a division proportion between the base set and the incremental set may be determined by the AutoML system 100 based on an empirical value, and different division proportions may be set for different task targets.

2: Retrain, by using the base set, the initial AI model determined in step S303, to obtain the base AI model, and evaluate prediction accuracy of the base AI model for each type by using the test data set, to obtain base prediction accuracy for each type, where base prediction accuracy for the j^{th} type of data is denoted by PA^{j}₀.

It should be understood that a specific method for AI model retraining and evaluation in step 1 and step 2 is similar to that in steps S304 and S305, and details are not described herein again.

3: Divide type-A data in the incremental set into k portions, where an amount of each portion of data may be the same or may be different. For each time of AI model training, one portion of type-A data is added. After each time of training, prediction accuracy of a currently trained intermediate AI model for type-A, type-B, type-C, and type-D data in the test data set is calculated, and a change amount of prediction accuracy for each type relative to base prediction accuracy is calculated. A change amount of prediction accuracy, for the j^{th} type of data, of an intermediate AI model obtained through training for which type-A data is added for the i^{th} time relative to prediction accuracy of the base AI model for the j^{th} type of data is denoted by ΔPA^{j}ᵢ. After type-A data is added for the k^{th} time, four prediction accuracy change amount sequences (which are respectively sequences of change amounts of prediction accuracy of the intermediate AI model in predicting type-A, type-B, type-C, and type-D data relative to base prediction accuracy in a process of adding type-A data for AI model training) can be obtained, where a prediction accuracy change amount sequence corresponding to the j^{th} type of data represents a set of change amounts of prediction accuracy of the intermediate AI model for the j^{th} type of data in the test data set relative to base prediction accuracy after type-A data is added for the first time to the k^{th} time. For example, each time type-A data is added, prediction accuracy of the intermediate AI model for type-B data in the test data set may change. A prediction accuracy change amount sequence corresponding to type-B data represents each change.

4: Calculate a correlation coefficient between an incremental sequence of type-A data and an obtained prediction accuracy change amount sequence corresponding to each type of data, where the correlation coefficient may be calculated by using a Pearson correlation coefficient, or may be calculated by using another correlation coefficient commonly used in statistics, such as a

Spearman coefficient or a Kendall coefficient. For example, after type-A data is added for AI model training, prediction accuracy change amount sequences corresponding to the type A, the type B, the type C, and the type D are obtained; and correlation coefficients between the incremental sequence of the type A and the prediction accuracy change amount sequences corresponding to the type A, the type B, the type C, and the type D are separately calculated, where the correlation coefficients corresponding to the type A, the type B, the type C, and the type D are respectively denoted by rA^{A}, rA^{B}, rA^{C}, and rA^{D}. Therefore, in this step, impact of adding type-A data for AI model training on prediction of the AI model for type-A, type-B, type-C, and type-D data can be obtained, and the impact may be determined based on the correlation coefficients. When a correlation coefficient between the incremental sequence of type-A data and a prediction accuracy change amount sequence corresponding to type-A data is comparatively large and indicates a positive correlation (the correlation coefficient is positive), it may be determined that adding type-A data for AI model training has positive impact on prediction accuracy for type-A data, and can improve prediction accuracy of the AI model for type-A data. When a correlation coefficient between the incremental sequence of type-A data and a prediction accuracy change amount sequence corresponding to type-B data is comparatively large and indicates a negative correlation (the correlation coefficient is negative), it may be determined that adding type-A data for AI model training has negative impact on prediction accuracy for type-B data, and reduces prediction accuracy of the AI model for type-B data. When a correlation coefficient between the incremental sequence of type-A data and a prediction accuracy change amount sequence corresponding to type-C data is comparatively small, it may be determined that adding type-A data for AI model training has small impact on prediction accuracy for type-C data.

It should be noted that the foregoing method in steps 3 and 4 is performed for each of the N types of data, thereby obtaining a correlation coefficient between adding each type of data and change amounts of prediction accuracy of the AI model in predicting the same type of data and another type of data.

S3053: Calculate a benefit coefficient of adding one type of data for prediction accuracy of the intermediate AI model.

Specifically, a preset correlation coefficient threshold is compared with each obtained correlation coefficient, and regression analysis continues to be performed on an incremental sequence and a prediction accuracy change amount sequence that correspond to a correlation coefficient greater than or equal to the correlation coefficient threshold. A linear regression analysis method may be used as a method for the regression analysis. For example, the incremental sequence is the incremental sequence of type-A data, and the corresponding prediction accuracy sequence is a prediction accuracy change amount sequence of the AI model for type-B data after type-A data is added. In this case, calculation is performed by using the incremental sequence [NA₁, NA₂, . . . , NAᵢ, . . . , NAₖ] and the corresponding prediction accuracy sequence [ΔPA^{B}₁, ΔPA^{B}₂, . . . , ΔPA^{B}ᵢ, ΔPA^{B}ₖ] and according to the following formula:

[ΔPA^{B}₁, ΔPA^{B}₂, . . . , ΔPA^{B}ᵢ, ΔPA^{B}ₖ]=bA^{B}*[NA₁, NA₂, . . . , NAᵢ, . . . , NAₖ]+hA^{B}

The foregoing formula is used to calculate a benefit coefficient bA^{B} that represents prediction accuracy, for type-B data, of an AI model obtained through training for which type-A data is added. Similarly, all benefit coefficients corresponding to prediction accuracy, for the same type of data and other data, of the AI model obtained through training for which type-A data is added are calculated according to the foregoing formula. A total benefit coefficient corresponding to the prediction accuracy of the AI model obtained through training for which type-A data is added is a sum of all the benefit coefficients corresponding to the prediction accuracy, for the same type of data and the other data, of the AI model obtained through training for which type-A data is added, and is denoted by BA.

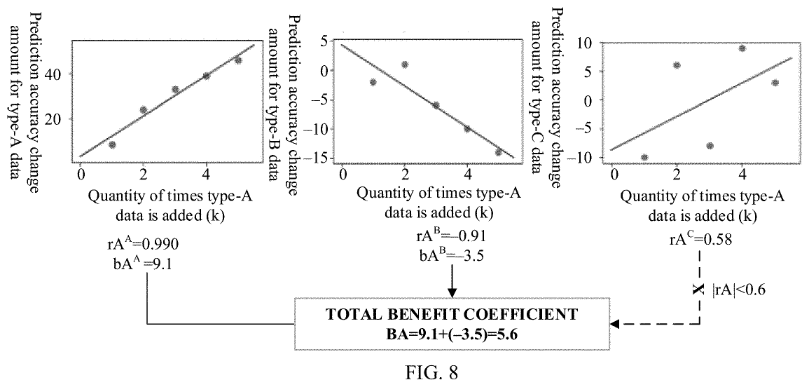

Calculation in steps S3052 and S3053 may be described by using a schematic diagram of calculation shown in FIG. 8 as an example. As shown in FIG. 8, in step S3052, correlation coefficients rA^{A}, rA^{B}, and rA^{C} between the incremental sequence of type-A data and prediction accuracy of the intermediate AI model for data of the three types A, B, and C after type-A data is added to train the base AI model are separately obtained through calculation. The preset correlation coefficient threshold is 0.6, and therefore, it may be determined that adding type-A data has comparatively large impact on prediction accuracy for type-A and type-B data, and has comparatively small impact on prediction accuracy for type-C data. Therefore, benefit coefficients bA^{A} and bA^{B} of adding type-A data to train the AI model for prediction of the AI model for type-A data and type-B data are further calculated. A total benefit coefficient of adding type-A data for prediction accuracy of the intermediate AI model is obtained through calculation based on bA^{A} and bA^{B}, and the total benefit coefficient is 5.6.

It should be understood that, for the N types with comparatively poor prediction accuracy that are obtained in S3051, S3052 and S3053 are performed to calculate impact (a correlation coefficient and a benefit coefficient) of adding data of each of the N types on prediction of the intermediate AI model for each type of data in the test data set, and a total benefit coefficient for the AI model. Obtained N total benefit coefficients are sorted, and an added type corresponding to one or more comparatively large benefit coefficients may be selected as one or more data types that the user is recommended to add most preferentially.

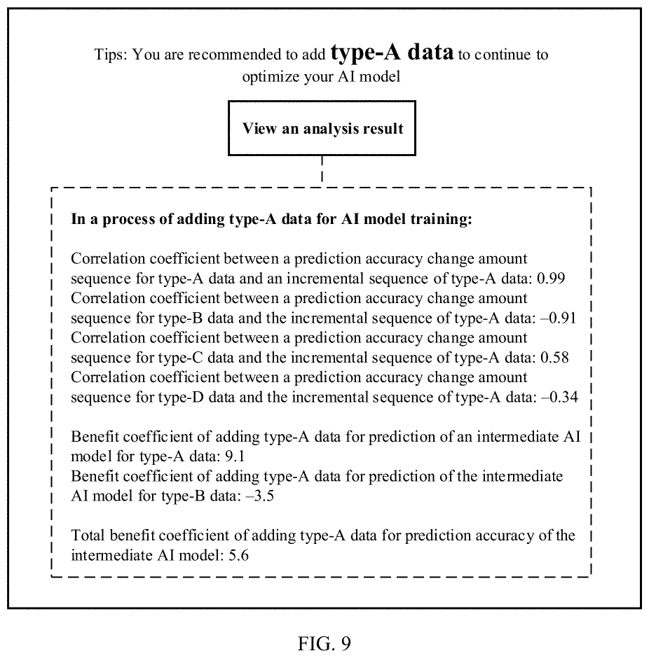

It should be noted that, in S306, impact of adding one type of data on prediction of the intermediate AI model for the same type of data and a different type of data, and a total benefit coefficient of adding one type of data for prediction accuracy of the intermediate AI model can both be displayed to the user on the GUI, where the impact and the total benefit coefficient are obtained in steps S3052 and S3053. Further, the AutoML system 100 further recommends, to the user based on these analysis results, one or more data types that should be added most preferentially. For example, as shown in FIG. 9, through analysis in steps S3052 and S3053, the AutoML system 100 displays the optimization manner to the user on the GUI, and the user can clearly see, on the GUI, the data type that should be added and that is recommended by the AutoML system 100 to the user. Further, the user may choose to view the analysis result, to learn a reason for which the AutoML system 100 recommends the user to add the one or more types of data.

S3054: Calculate an expected effect of prediction accuracy of an AI model obtained through training for which one type of data is added.

Total prediction accuracy of the intermediate AI model after each time of training is calculated based on prediction accuracy, obtained in S3053, of the intermediate AI model for each type of data after each time of AI model training for which one type of data is added. The total prediction accuracy of the intermediate AI model after each time of training may be an average value or a weighted average value of prediction accuracy of the intermediate AI model for all types after each time of training (a weighting coefficient may be determined based on an amount of each type of data in the test data set). For example, an increment of type-A data used for AI model training is [NA₁, NA₂, . . . , NAᵢ, . . . , NAₖ], and in a process of adding type-A data, a prediction accuracy sequence of the trained intermediate AI model for predicting type-A data is [PA^{A}₁, PA^{A}₂, . . . , PA^{A}ᵢ, . . . , PA^{A}ₖ], a prediction accuracy sequence of the trained intermediate AI model for predicting type-B data is [PA^{B}₁, PA^{B}₂, . . . , PA^{B}ᵢ, . . . , PA^{B}ₖ], a prediction accuracy sequence of the trained intermediate AI model for predicting type-C data is [PA^{C}₁, PA^{C}₂, . . . , PA^{C}ᵢ, . . . , PA^{C}ₖ], and a prediction accuracy sequence of the trained intermediate AI model for predicting type-D data is [PA^{D}₁, PA^{D}₂, . . . , PA^{D}ᵢ, . . . , PA^{D}ₖ]. Through calculation of an average value of all prediction accuracy in each of the four sequences, a prediction accuracy sequence of the trained intermediate AI model in a process of adding type-A data can be obtained, that is, [PA₁, PA₂, . . . , PAᵢ, . . . , PAₖ]. Curve fitting is performed on the increment [NA₁, NA₂, . . . , NAᵢ, . . . , NAₖ] of type-A data and the prediction accuracy sequence [PA₁, PA₂, . . . , PAᵢ, . . . , PAₖ] of the trained intermediate AI model, to obtain a formula G that can represent the curve relationship. Expected prediction accuracy of an AI model obtained through training for which a specific amount of type-A data continues to be added may be calculated according to the formula G. Further, an expected effect of prediction accuracy of the AI model obtained through training for which the specific amount of type-A data is added may be obtained through calculation based on the expected accuracy.

Optionally, for calculating the prediction accuracy sequence [PA₁, PA₂, . . . , PAᵢ, . . . , PAₖ] of the AI model trained in the process of adding type-A data, type-A data may also be gradually added according to the incremental experiment method in S3052, to gradually train the base AI model; and an intermediate AI model obtained through each time of training is evaluated by using test data, to obtain prediction accuracy, for all the test data, of the intermediate AI model obtained through each time of training, so as to obtain the prediction accuracy sequence [PA₁, PA₂, . . . , PAᵢ, . . . , PAₖ].

It should be understood that, in an embodiment, for the data type (which may be one or more data types) that is recommended to be added and that is mentioned in the optimization manner, an expected effect of total prediction accuracy of an AI model obtained through training for which data of the recommended data type is added may be calculated in S3054 after S3053 is completed. For example, in S3053, the AutoML system 100 recommends, based on the analysis, the user to continue to add type-A data, and in S3054, the AutoML system 100 continues to calculate an expected effect of prediction accuracy of an AI model obtained through training for which the type-A data is added, to display the expected effect to the user. In another embodiment, in S3054, an expected effect of prediction accuracy of an AI model obtained through training for which each type of data continues to be added may be separately calculated for each data type on which analysis is performed in S3053.

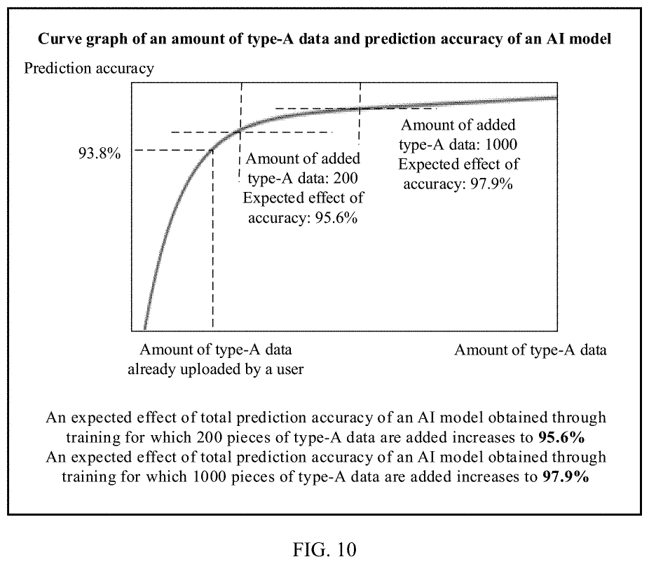

It should be noted that, in S306, both a prediction accuracy curve obtained through the foregoing fitting and an expected effect, obtained through further calculation, of prediction accuracy of the AI model after a specific amount of data is added may be displayed on the GUI, so that the user determines, based on the expected effect of prediction accuracy of the AI model, whether to add data according to the optimization manner. FIG. 10 shows a GUI, and the GUI displays a curve graph of prediction accuracy of an AI model in a process of training for which type-A data is used. In the figure, a horizontal coordinate represents an amount of type-A data, and a vertical coordinate represents prediction accuracy of the AI model after the AI model is trained by using the amount of type-A data in the horizontal coordinate. As shown in FIG. 10, the user can learn that an expected effect of total prediction accuracy of the AI model increases to 95.6% after 200 pieces of type-A data are added for training, and the expected effect of total prediction accuracy of the AI model increases to 97.9% after 1000 pieces of type-A data are added for training. Optionally, in FIG. 10, the user may further click any point on the curve by using a mouse cursor, and the GUI correspondingly displays an amount of added type-A data corresponding to the point on the curve and an expected effect of prediction accuracy of the AI model after the amount of type-A data is used to continue training of the AI model.

It should be understood that although the method in S3051 to S3054 is described by using an example in which the task target of the user is image classification, the method for analyzing the AI model and providing the optimization manner and the expected effect of optimization for the user described in S3051 to S3054 may be actually used for a plurality of types of task targets, and a type of the task target is not limited in this application. The foregoing method may be used to perform optimization analysis on any AI model that needs to be trained by using different data sets, so as to provide a more accurate and convincing optimization manner and expected effect for a user. For example, the task target of the user may be vehicle license plate recognition, facial recognition, target detection, or video review.

When the AutoML system 100 provided in this application performs optimization analysis, the AutoML system 100 may alternatively perform classification on the data set based on one or more attributes (for example, a background color of an image, an age in which a video is created, or a nation of text) of the data in the data set uploaded by the user, instead of performing classification based on the label of the data in the data set uploaded by the user; and further analyze the impact of each type of data under one or more attribute classifications on AI model training.

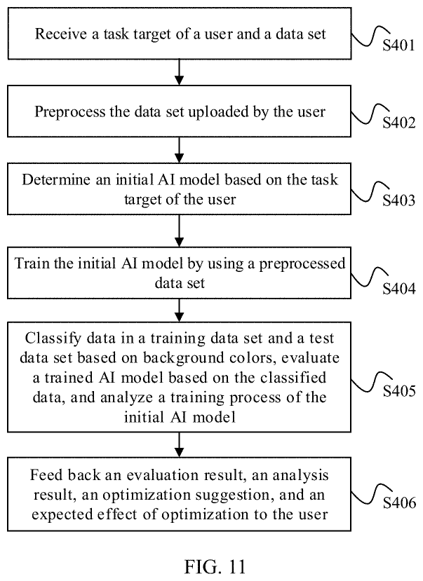

The following describes another embodiment provided in this application, with reference to FIG. 11.

S401: An AutoML system 100 receives a task target selected by a user on a GUI and a data set, where the task target is vehicle license plate recognition, the data set is a data set that includes different vehicle license plates of nations, and a label of each vehicle license plate in the data set is a character string corresponding to a license plate number of the vehicle license plate.

S402: The AutoML system 100 preprocesses the data set based on the data set of the user, where a preprocessing operation includes one or more of the operations mentioned in S302, and details are not described herein again.

S403: The AutoML system 100 determines, for the user based on the task target, an initial AI model used to implement the task target.

S404: The AutoML system 100 trains the AI model by using the data set, to obtain a trained AI model.

S405: The AutoML system 100 classifies the vehicle license plates in a training data set and a test data set based on different background colors, where the background color is an attribute of data in the data set, for example, the vehicle license plates may be classified into four types: black, green, blue, and red; evaluates the effect of the trained AI model by using the test data set on which classification by color has been performed; and analyzes the training of the initial AI model by using the training data set on which classification by color has been performed.

Vehicle license plates in the test data set are separately input to the trained AI model. Similarly to S3051, the prediction accuracy of the currently trained AI model in predicting license plate numbers of green, blue, black, and red vehicle license plates is evaluated. It is found that the trained AI model has comparatively poor prediction accuracy for character strings on vehicle license plates whose background colors are black and red.

According to the method in S3052 to S3054, the impact of using vehicle license plates whose background colors are black and red in the training data set in the process of training the initial AI model on the prediction accuracy of the AI model for vehicle license plates of the same color types and other color types is separately analyzed. A total benefit coefficient of adding data of one color type for prediction accuracy of the AI model is calculated. Further, an expected effect of total prediction accuracy of an AI model obtained through training for which data of one color type is added is calculated. A specific implementation of the foregoing evaluation and analysis method is the same as S3051 to S3054, and details are not described herein again.

S406: Display an analysis result and an optimization manner to the user based on the evaluation and analysis in S405, where the optimization manner may be: adding a vehicle license plate whose background color is black to continue to optimize the AI model. An expected effect of AI model optimization for which a specific quantity is added, for example, a proportion by which prediction accuracy of the AI model is improved, may be further provided for the user.

In the foregoing embodiment, although the data is not classified by color attribute in the data set uploaded by the user, to analyze the impact of the background of a vehicle license plate on character recognition, the AutoML system 100 performs an operation of classification by attribute (color) on the data set when performing optimization analysis on the AI model, so that prediction accuracy of the trained AI model for vehicle license plates of different colors can be analyzed, to provide the user with an AI model optimization manner in another aspect.

Optionally, in another embodiment, when analyzing the trained AI model and the data set used for training, the AutoML system 100 may perform classification on the data set based on attributes in a plurality of aspects, and analyze the impact of each type of data set under an attribute in each aspect on AI model training. For example, when the task target of the user is facial recognition, during analysis, classification may be performed on the training data set and the test data set based on genders of faces in the data set, to obtain two types: male and female, and recognition accuracy of the trained AI model for males and females and the impact of male and female training data on the accuracy of the AI model are analyzed. Classification may be further performed on the training data set and the test data set based on ages of the faces in the data set, to obtain the following types: 20-30, 30-40, 40-50, 50-60, and 60 or above 60, and recognition accuracy of the trained AI model for faces in different age phases and the impact of training data in each age phase on the accuracy of the AI model are analyzed. Because the AutoML system analyzes the training of the AI model based on attributes in two aspects, the optimization manner provided by the AutoML system 100 for the user by using the GUI may be: adding female facial data and facial data whose age is 60 years or older.

This application further provides the AutoML system 100 shown in FIG. 1. Modules and functions included in the AutoML system are described above, and details are not described herein again. In an embodiment, the user I/O module 101 in the AutoML system 100 is configured to perform the method described in steps S301 and S306, or configured to perform the method described in S401 and S406; the data preprocessing module 102 is configured to perform the method described in step S302, or configured to perform the method described in

S402; the model determining module 103 is configured to perform the method described in step S303, or configured to perform the method described in S403; the model training module 104 is configured to perform the method described in step S304, or configured to perform the method described in S404; and the model optimization analysis module 105 is configured to perform the method described in step S305, or configured to perform the method described in S405.

It should be noted that, in an embodiment, the model optimization analysis module is further configured to perform S3051 to S3054.

This application further provides the computing device 200 shown in FIG. 4. The processor 202 in the computing device 200 reads the program and the data set stored in the memory 201, to perform the method performed by the foregoing AutoML system.

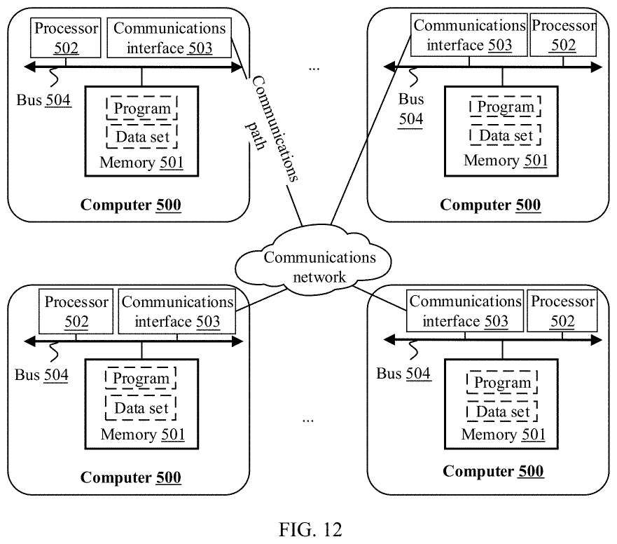

Because all the modules in the AutoML system 100 provided in this application may be deployed in a distributed manner on a plurality of computers in the same environment or different environments, this application further provides a computing device shown in FIG. 12. The computing device includes a plurality of computers 500. Each computer 500 includes a memory 501, a processor 502, a communications interface 503, and a bus 504. The memory 501, the processor 502, and the communications interface 503 are communicatively connected to each other through the bus 504.

The memory 501 may be a read-only memory (ROM), a static storage device, a dynamic storage device, or a random access memory (RAM). The memory 501 may store a program. When the program stored in the memory 501 is executed by the processor 502, the processor 502 and the communications interface 503 are configured to perform some of the methods for training and optimizing an AI model for a user by an AutoML system. The memory may further store a data set. For example, some of storage resources in the memory 501 are grouped into a data set storage module, configured to store a data set required by the AutoML system, and some of the storage resources in the memory 501 are grouped into an AI model storage module, configured to store an AI model library.

The processor 502 may be a general-purpose central processing unit (CPU), a microprocessor, an application-specific integrated circuit (ASIC), a graphics processing unit (GPU), or one or more integrated circuits.

Alternatively, the processor 502 may be an integrated circuit chip having a signal processing capability. In an implementation process, some or all functions of the AutoML system in this application may be implemented by using an integrated logic circuit of hardware in the processor 502 or instructions in a form of software. The processor 502 may alternatively be a general-purpose processor, a digital signal processor (DSP), an application-specific integrated circuit (ASIC), a field programmable gate array (FPGA) or another programmable logic device, a discrete gate or transistor logic device, or a discrete hardware component, which can implement or perform the methods, steps, and logical block diagrams that are disclosed in the foregoing embodiments of this application. The general-purpose processor may be a microprocessor, or the processor may be any conventional processor or the like. Steps of the methods disclosed with reference to the foregoing embodiments of this application may be directly executed and completed by using a hardware decoding processor, or may be executed and completed by using a combination of hardware in a decoding processor and a software module. The software module may be located in a mature storage medium in the art, such as a random access memory, a flash memory, a read-only memory, a programmable read-only memory, an electrically erasable programmable memory, or a register. The storage medium is located in the memory 501. The processor 502 reads information in the memory 501, and implements some functions of the AutoML system in the embodiments of this application in combination with hardware of the processor 502.

The communications interface 503 uses, for example but not limited to, a transceiver module such as a transceiver to implement communication between the computer 500 and another device or a communications network. For example, a data set may be obtained through the communications interface 503.

The bus 504 may include a path for transmitting information between components (for example, the memory 501, the processor 502, and the communications interface 503) of the computer 500.

A communications channel is established between the computers 500 by using a communications network. Any one or more of a user I/O module 101, a data preprocessing module 102, a model determining module 103, a model training module 104, a model optimization analysis module 105, a data set storage module 106, and an AI model storage module 107 run on each computer 500. Any computer 500 may be a computer (for example, a server) in a cloud data center, a computer in an edge data center, or a terminal computing device.

A description of a procedure corresponding to each of the accompanying drawings has a focus. For a part that is not described in detail in a procedure, refer to a related description of another procedure.

All or some of the foregoing embodiments may be implemented by software, hardware, firmware, or any combination thereof. When software is used for implementation, all or some of the embodiments may be implemented in a form of a computer program product. The computer program product providing AutoML includes one or more computer instructions for performing AutoML. When these computer program instructions are loaded and executed on a computer, all or some of the procedures or functions according to FIG. 5, FIG. 6, or FIG. 11 in the embodiments of the present invention are generated.

The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium is a readable storage medium that stores computer program instructions providing AutoML. The computer-readable storage medium may be any usable medium accessible to a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium (for example, an SSD).

What is claimed is:

1. An automatic machine learning (AutoML) method, comprising:
receiving a task target of a user and a first data set;
determining an initial artificial intelligence (AI) model based on the task target, wherein the initial AI model is used to implement the task target;
training the initial AI model based on the first data set, to obtain a trained AI model;
analyzing the training of the initial AI model based on the first data set, to obtain an analysis result, wherein the analysis result comprises an impact of at least one type of data in the first data set on the training of the initial AI model; and
providing an optimization manner of the trained AI model to the user based on the analysis result, wherein the optimization manner comprises: uploading a second data set for optimizing the trained AI model.

2. The method according to claim 1, wherein the method further comprises:
providing an expected effect of optimization of the trained AI model for the user, wherein the expected effect indicates a prediction accuracy that is to be achieved after performing optimization training on the trained AI model based on the second data set.

3. The method according to claim 1, wherein the first data set comprises a training data set and a test data set;
before the analyzing of the training of the initial AI model based on the first data set, to obtain an analysis result, the method further comprises:
evaluating prediction accuracy of the trained AI model for each type of data in the test data set; and
the analyzing of the training of the initial AI model based on the first data set, to obtain an analysis result comprises:
determining at least one type of data in the training data set based on the prediction accuracy for each type of data in the test data set, to analyze the training of the initial AI model; and
analyzing the impact of the at least one type of data in the training data set on the training of the initial AI model by using an incremental experiment method, to obtain the analysis result.

4. The method according to claim 3, wherein the analyzing the impact of the at least one type of data in the training data set on the training of the initial AI model by using an incremental experiment method, to obtain the analysis result comprises:
dividing the training data set into a base set and an incremental set;
training the initial AI model by using the base set, to obtain a base AI model;
for each of the at least one type of data in the incremental set, dividing the type of data into a plurality of portions, and adding the plurality of portions of data one by one to train the base AI model, to obtain an intermediate AI model;
calculating a change amount of prediction accuracy of the intermediate AI model relative to that of the base AI model after each time of training; and
obtaining a benefit coefficient of each of the at least one type of data for the prediction accuracy of the intermediate AI model based on the change amount of the prediction accuracy and the type of data.

5. The method according to claim 3, wherein the second data set comprises one or more types of data, and the type of the data in the second data set is a type of data whose benefit coefficient for the prediction accuracy of the intermediate AI model is greater than a preset threshold.

6. The method according to claim 1, wherein the method further comprises:
receiving the second data set uploaded by the user; and
performing optimization training on the trained AI model based on the second data set.

7. The method according to claim 1, wherein before the analyzing of the training of the initial AI model based on the first data set, to obtain a trained AI model, the method further comprises:
classifying data in the first data set based on an attribute of the data in the first data set.

8. The method according to claim 1, wherein data in the first data set and the second data set has labels, and types of the data in the first data set and the second data set are the same as the labels of the data in the first data set and the second data set.

9. The method according to claim 1, wherein the method further comprises:
preprocessing data in the received first data set and data in the second data set separately, wherein the preprocessing comprises one or more of the following operations:
(1) modifying size specifications of the data;
(2) checking the data;
(3) encoding and converting the data;
(4) classifying the data by attribute; or
(5) extracting features of the data.

10. A computing device, wherein the computing device comprises a memory and a processor, and the memory is configured to store a group of computer instructions; and
the processor executes the group of computer instructions stored in the memory, to perform:
receiving a task target of a user and a first data set;
determine an initial artificial intelligence (AI) model based on the task target, wherein the initial AI model is used to implement the task target;
training the initial AI model based on the first data set, to obtain a trained AI model;
analyzing the training of the initial AI model based on the first data set, to obtain an analysis result, wherein the analysis result comprises an impact of at least one type of data in the first data set on the training of the initial AI model; and
providing an optimization manner of the trained AI model to the user based on the analysis result, wherein the optimization manner comprises: uploading a second data set for optimizing the trained AI model.

11. The computer device according to claim 10, wherein the processor further performs:
providing an expected effect of optimization of the trained AI model to the user, wherein the expected effect indicates a prediction accuracy that is to be achieved after performing optimization training on the trained AI model based on the second data set.

12. The computer device according to claim 10, wherein the first data set comprises a training data set and a test data set, wherein the processor further performs:
evaluating prediction accuracy of the trained AI model for each type of data in the test data set; and
determining at least one type of data in the training data set based on the prediction accuracy for each type of data in the test data set, to analyze the training of the initial AI model; and
analyzing the impact of the at least one type of data in the training data set on the training of the initial AI model by using an incremental experiment method, to obtain the analysis result.

13. The computer device according to claim 12, wherein the processor further performs:
dividing the training data set into a base set and an incremental set;
training the initial AI model by using the base set, to obtain a base AI model;
for each of the at least one type of data in the incremental set, dividing the type of data into a plurality of portions, and adding the plurality of portions of data one by one to train the base AI model, to obtain an intermediate AI model;
calculating a change amount of prediction accuracy of the intermediate AI model relative to that of the base AI model after each time of training; and
obtaining a benefit coefficient of each of the at least one type of data for the prediction accuracy of the intermediate AI model based on the change amount of the prediction accuracy and the type of data.

14. The computer device according to claim 12, wherein the second data set comprises one or more types of data, and the type of the data in the second data set is a type of data whose benefit coefficient for the prediction accuracy of the intermediate AI model is greater than a preset threshold.

15. The computer device according to claim 10, wherein the processor further performs:
receiving the second data set; and
performing optimization training on the trained AI model based on the second data set.

16. The computer device according to claim 10, wherein the processor further performs:
classifying data in the first data set based on an attribute of the data in the first data set.

17. The computer device according to claim 10, wherein data in the first data set and the second data set has labels, and types of the data in the first data set and the second data set are the same as the labels of the data in the first data set and the second data set.

18. The computer device according to claim 10, wherein the processor further performs:
preprocessing the data in the received first data set and the second data set separately, wherein the preprocessing comprises one or more of the following operations:
(1) modifying size specifications of the data;
(2) checking the data;
(3) encoding and converting the data;
(4) classifying the data by attribute; or
(5) extracting features of the data.

19. A non-transitory readable storage medium, wherein the non-transitory readable storage medium stores computer program code, and when the computer program code is executed by a computing device, the computing device performs:
receiving a task target of a user and a first data set;
determining an initial artificial intelligence (AI) model based on the task target, wherein the initial AI model is used to implement the task target;
training the initial AI model based on the first data set, to obtain a trained AI model;
analyzing the training of the initial AI model based on the first data set, to obtain an analysis result, wherein the analysis result comprises an impact of at least one type of data in the first data set on training of the initial AI model; and
providing an optimization manner of the trained AI model to the user based on the analysis result, wherein the optimization manner comprises: uploading a second data set for optimizing the trained AI model.

20. The non-transitory readable storage medium according to claim 19, wherein when the computer program code is executed by the computing device, the computing device further performs:
providing an expected effect of optimization of the trained AI model to the user, wherein the expected effect indicates a prediction accuracy that is to be achieved after performing optimization training on the trained AI model based on the second data set.
